(19) United States
(12) Patent Application Publication
(10) Pub. No.: US 2007/0080864 A1
(43) Pub. Date: Apr. 12, 2007

(54) Broadband proximity-coupled cavity backed patch antenna

(75) Inventor: Eswarappa Channabasappa, Acton, MA (US)

Correspondence Address: TYCO TECHNOLOGY RESOURCES, 4550 NEW LINDEN HILL ROAD, SUITE 140, WILMINGTON, DE, 19808-2952, US

(73) Assignee: M/A-Com, Inc., Lowell, MA (US)

(21) Appl. No.: 11/247,540

(22) Filed: Oct. 11, 2005

(51) Int. Cl. H01Q 1/38

(52) U.S. Cl. 343/700 MS

(57) ABSTRACT

A patch antenna in accordance with the present invention comprises a patch optionally surrounded by a top ground plane, a feed line disposed beneath the patch and separated therefrom by a thin substrate, a middle ground plane separated from the feed line by another thin substrate, and a bottom ground plane disposed beneath the middle ground plane and preferably separated therefrom by foam or another lightweight dielectric layer. Conductive vias run between the top ground plane and the middle ground plane as well as from the middle ground plane to the bottom ground plane. The middle ground plane is essentially annular, defining an opening in the middle thereof, such that there is a dielectric cavity beneath the patch and the feed line in the space defined by the bottom ground plane, the middle ground plane and the vias that run between the middle ground plane and the bottom ground plane. This cavity can be filled with low cost, low weight foam, rather than the heavier, more costly conventional substrates.

### FIELD OF THE INVENTION

The present invention relates to communications antennas, and more specifically relates to novel patch antennas suitable for use in antenna arrays, such as may be used in wireless communication systems.

### BACKGROUND OF THE INVENTION

Patch antennas are commonly used in telecommunications systems such as microwave telecommunications systems because they can be extremely compact. However, a drawback of patch antennas is that they tend to have narrow bandwidth.

A patch antenna typically comprises a flat, square radiating patch (although the patch can be many shapes, including a circular, triangular, and rectangular), a feed line for feeding a signal to the patch (or receiving a signal from the patch, if it is a receiving antenna rather than a transmitting antenna) and a ground plane disposed beneath the patch, and separated from it by a dielectric (which could be air). In the following discussion, we shall use a transmitting antenna for exemplary purposes. The feed line typically might comprise a microstrip disposed on one side of a substrate or a strip line disposed in the middle of two substrates joined face to face (the strip line being formed on one of the substrates) with two opposing ground planes formed on the opposing outside surface of each of the substrates, respectively. The length L of the patch typically is selected to be ½ of the wavelength of the signal that the patch is intended to radiate (or receive), so that the patch resonates at the frequency of the signal and thereby transmits the desired wireless signal. The “length” of a patch antenna generally refers to the distance between the radiating edges of the patch. Thus, for example, in a square patch, this would be the length of a side of the square. For a circular patch, this would be the diameter of the patch. For a rectangular patch, it would be the orthogonal distance between the two radiating edges of the patch (which could be either the short or the long edges depending on the design). Determining the “length” of a triangular patch is a bit more complex, but also can be calculated.

Note that terms such as vertical and horizontal as used in this specification are merely relative terms and do not signify a particular orientation relative to the earth or anything else. Rather, the term “horizontal” or “horizontal direction” generally refers to the direction parallel to the patch plane defined by the large (e.g. square) surface of the patch and the term “vertical” or “vertical direction” generally refers to the direction perpendicular to the large surface of the patch.

The feed line of a patch antenna may be coupled directly to the patch in order to directly drive (or receive) the signal. However, a patch antenna also may be parasitically capacitively driven from a proximity coupled feed line. Particularly, the feed line, whether it is a microstrip or a stripline, may be electrically separated from the patch by a dielectric material, including air, and may drive (or receive) the waves on the patch capacitively.

FIGS. 1A and 1B are top and side views, respectively, illustrating an exemplary conventional patch antenna 10. Patch antenna 10 comprises a substrate 12 bearing a metal patch 14 on the top surface thereof. The metal patch 14 is peripherally surrounded by a top ground plane 16. The patch 14 and the top ground plane 16 may be created by conventional semiconductor manufacturing techniques such as depositing one or more metal layers on the substrate 12 by any one of a number of techniques known in the semiconductor fabrication industry and etching them by any one of a number of techniques known in the semiconductor fabrication industry to create the two distinct metallizations, i.e., the ground plane 16 and the patch 14. A feed line 18 may be etched on the opposite side of the substrate 12, but more likely is etched on a second substrate 20 disposed below the first substrate 12 and bonded thereto. The feed line 18 is coupled to a drive signal (not shown). As previously noted, the feed line capacitively drives a signal on the patch. Another substrate 20 is disposed below the proximity feed line 18. The feed line 18 alternately may be deposited on the top surface of the second substrate 20, rather than the bottom surface of the first substrate 12. A bottom ground plane 22 is deposited on the bottom of the second substrate 20. Plated through vias 24 through the substrates 12 and 20 conductively connected the top ground plane 16 to the bottom ground plane 22.

The vias 24 couple the top and bottom ground planes to each other and loosely form a shielded cavity around the patch. This helps to minimize coupling between adjacent patch antennas in an array of patch antennas. Particularly, patch antennas of this type may be arranged in arrays of hundreds or even thousands of patch antennas. More particularly, multiple patch antennas may be fabricated on large substrates, such as substrates 12 and 20, that contain multiple patch antennas. The fields surrounding the vias help isolate the patch antennas from each other.

As previously noted, patch antennas of this type tend to have relatively narrow bandwidth and, therefore, have somewhat limited applications. Within limits, the bandwidth of the antenna can be increased by increasing the volume of the antenna. The volume generally is the space between the two ground planes and the vias, generally called the cavity of the antenna. Accordingly, bandwidth can be increased by increasing the distance between the patch and the bottom ground plane (i.e., increasing the vertical dimension of the antenna). It also can be increased by increasing the horizontal dimension of the antenna, but this is undesirable in an antenna array environment for several reasons, most notably because it would increase mutual coupling between the antenna elements.

However, varying these distances can affect the bandwidth only within a limited range. Furthermore, it is virtually always a goal to reduce the size and weight of electronic components, particularly electronic components in telecommunication devices. Even furthermore, it is well-known that, for purposes of maximizing the efficiency of the feed network, thinner substrates are desirable. Also, thinner substrates are less expensive and low in weight/mass. Accordingly, there are design factors pulling in opposite directions with respect to the cavity volume of a patch antenna.

A modern trend in the design of antennas for wireless devices is to combine two or more antenna elements into an antenna array. Each antenna element in such an array should have a small footprint, a low level of mutual coupling with neighboring elements, a low element return loss, a low axial ratio (in case of circular polarization), and a large frequency bandwidth. For a typical antenna element in an antenna array, however, these requirements typically are at odds with each other. For example, the larger the bandwidth and the larger the size of an antenna element, the stronger the mutual coupling between the antenna element and its neighboring elements in the antenna array.

A known technique to reduce the size of the patch antenna element is to select a dielectric substrate 12, 20 with a very high permittivity ∈S (e.g., ∈S=6 to 20 relative to air). The high permittivity substrate reduces the resonant frequency of the patch antenna element 14, and hence patch antenna element l4 can be made smaller to operate at a given signal frequency f. More specifically, for the patch antenna element shown in FIGS. 1A and 1B, and for a given signal frequency f, the length of the patch antenna element is conventionally selected to be inversely proportional to the square root of the permittivity ∈S of the substrate 12, 20. For example, if the length of the patch were nominally 1 cm for a substrate permittivity of 1, the length could be reduced to 0.5 cm for a substrate having a permittivity of 4, or to 0.33 cm for a substrate having a permittivity of 9. The effect of the increased dielectric permittivity is to raise the capacitance between the patch 14 and bottom ground plane 22 and thereby to lower the resonant frequency. Unfortunately, the increased capacitance decreases the bandwidth of the antenna element.

A known technique to increase the frequency bandwidth is to add an additional patch above the first patch 14, resulting in a “stacked patch antenna.” Stacked patch antennas have been described in the article entitled “Stacked Microstrip Antenna with Wide Bandwidth and High Gain” by Egashira et al., published in IEEE Transactions on Antennas and Propagation, Vol. 44, No. 11 (November 1996); and in U.S. Pat. Nos. 6,759,986; 6,756,942; and 6,806,831. For instance, another patch can be placed directly above the first patch 14 and separated therefrom by a foam dielectric having a permittivity similar to air. A signal to be transmitted is input to the antenna through feed line 18, which signal capacitively drives both patches simultaneously. The second patch parasitically couples to the drive signal by parasitically capacitively coupling to the first patch 14. The additional resonance provided by the second patch increases the frequency bandwidth of the antenna. It also enhances the gain.

In conventional stacked patch antennas, however, the second and subsequent patches must be fairly large in comparison with the first patch. As a result, when stacked patch antenna elements are combined in an antenna array, adjacent elements exhibit a strong mutual coupling effect on each other, which negatively impacts antenna element gain, radiation patterns, and bandwidth.

Accordingly, it is an object of the present invention to provide an improved patch antenna.

It is another object of the present invention to provide a patch antenna with increased bandwidth capability.

It is a further object of the present invention to provide a broadband proximity-coupled cavity-backed patch antenna.

It is yet a further object of the present invention to provide an improved patch antenna array.

### SUMMARY OF THE INVENTION

A patch antenna in accordance with the invention comprises a patch optionally surrounded by a top ground plane, a feed line disposed beneath the patch and separated therefrom by a thin substrate, a middle ground plane separated from the feed line by another thin substrate, and a bottom ground plane disposed beneath the middle ground plane and preferably separated therefrom by foam or another lightweight dielectric layer. Conductive vias run between the top ground plane and the middle ground plane as well as from the middle ground plane to the bottom ground plane. The vias may run continuously between the three ground planes. Alternately, the vias between the top and middle ground planes and the vias between the middle and bottom ground planes may be separate vias. The middle ground plane is essentially annular, defining an opening in the middle thereof, such that there is a dielectric cavity beneath the patch and the feed line in the space defined by the bottom ground plane, the middle ground plane and the vias that run between the middle ground plane and the bottom ground plane. This cavity can be filled with low cost, low weight foam, rather than the heavier, more costly conventional substrates.

This cavity creates a large space underneath the patch and feed line and thus increases the bandwidth of the antenna with little added weight.

Additional patches can be stacked on top of the patch in order to create multi-layer patch antennas with broader bandwidth and greater gain. The patches may be spaced from each other by low cost and lightweight foam.

### BRIEF DESCRIPTION OF THE DRAWINGS

FIG. 1A is a top plan view of a conventional proximity-coupled cavity-backed patch antenna.

FIG. 1B is a cross-sectional side view of the patch antenna of FIG. 1A.

FIG. 2A is a top plan view of a patch antenna in accordance with a first embodiment of the present invention.

FIG. 2B is a cross-sectional side view of the patch antenna of FIG. 2A.

FIG. 3A is a top plan view of a patch antenna in accordance with a second embodiment of the present invention.

FIG. 3B is a cross-sectional side view of the patch antenna of FIG. 3A.

FIG. 4A is a top plan view of a patch antenna in accordance with a third embodiment of the present invention.

FIG. 4B is a cross-sectional side view of the patch antenna of FIG. 4A.

FIG. 5A is a top plan view of a patch antenna in accordance with a fourth embodiment of the present invention.

FIG. 5B is a cross-sectional side view of the patch antenna of FIG. 5A

FIG. 6 is a perspective exploded view of a stacked patch antenna in accordance with an embodiment of the present invention.

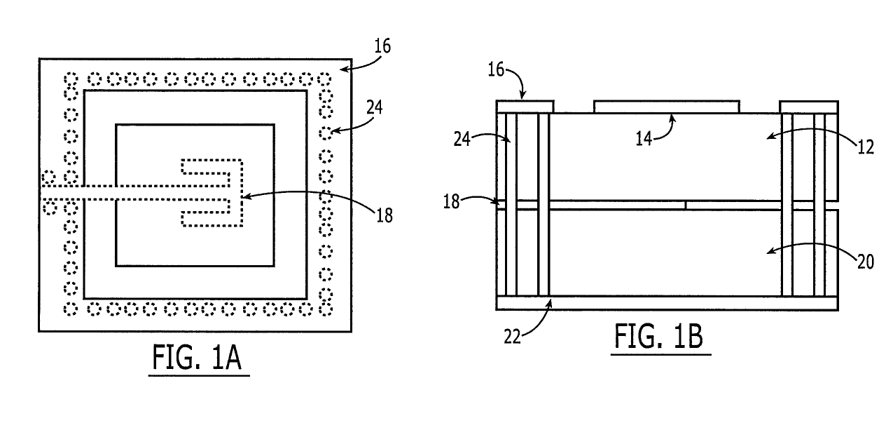

### DETAILED DESCRIPTION OF THE INVENTION

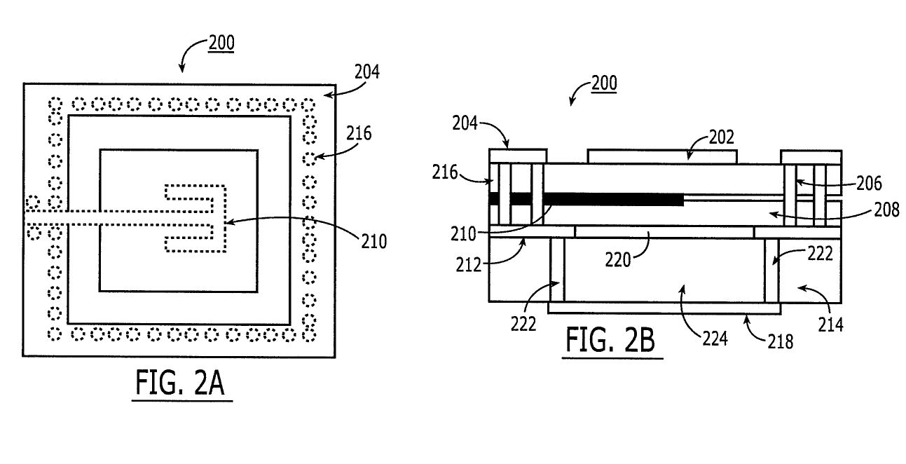

FIGS. 2A and 2B are top plan and cross-sectional side views, respectively, of a proximity-coupled cavity-backed patch antenna 200 in accordance with a first embodiment of the present invention. The antenna patch 202 is disposed on top of a thin substrate 206. It is peripherally surrounded by a top ground plane 204.

Substrate 206 may be any low loss substrate material conventionally used by those of skill in the art for constructing patch antennas, such as RT Duroid®, or a Teflon-based substrate, such as manufactured by Rogers, Taconics and Arlon. It also could be very thin flexible substrate (normally known as Flex). Such substrates typically have a permittivity of about 2 to about 4.

Disposed on the top side of a second, thin substrate 208 and/or on the underside of the first substrate 206 is a feed line 210. The feed line 210 may be a microstrip or a strip line. A middle ground plane 212 is disposed on the bottom side of the second substrate 208. The middle ground plane 212 is a square, peripheral band of conductor defining an opening 220 in the middle. The middle ground plane 212, like the overall patch antenna itself, can have a number of shapes in top plan view and should generally match the shape of the patch. For instance, if the antenna element is circular, then this opening has to be circular). However, for practical purposes pertaining to fabrication and efficiency in terms of packing many antennas of an array in as small an area as possible, will almost always be square or rectangular. The top ground plane 204 and middle ground plane 212 are electrically connected by a plurality of plated vias 216 running through the thicknesses of the first and second substrates 206 and 208.

A bottom ground plane 218 is positioned below the middle ground plane 212 and is separated therefrom by a lightweight foam 214 or other dielectric substrate. Preferably, the foam or other dielectric substrate 214 is lightweight and inexpensive. Another set of conductive vias 222 electrically connect the middle ground plane 212 to the bottom ground plane 218.

The ground planes 204, 212, 218, feed line 210, and patch 202 may be any conductive material, including copper (with or without tin or gold plating), zinc, aluminum, steel, or gold. Typically, the metal used for the conductors on printed circuit boards is copper, which often is tin or gold plated in order to prevent oxidization/corrosion, the copper traces may be tin or gold plated).

In the exemplary embodiment shown in FIGS. 2A and 2B, the vias 222 are not collinear with the vias 216. However, in other embodiments, they may be collinear. In this particular embodiment, the lower vias 222 intersect the middle ground plane 212 close to the inner edge of the middle ground plane that defines the opening 220. The bottom ground plane 218 is a solid, planar piece of conductive material sized just large enough and positioned so that the conductive vias 222 meet it near its outer peripheral edge. The bottom ground plane can be implemented by depositing copper on the bottom of the dielectric substrate 214.

The middle ground plane 212, vias 222, and bottom ground plane 218 define a cavity 224 beneath the patch 202 and feed line 210 that capacitively loads the patch and also enhances the energy storage for the patch and, hence, allows for greater bandwidth. In this embodiment, the cavity 224 is filled with foam or other dielectric material 214. However, as will be seen in later discussed embodiments of the invention, the cavity may be an air or vacuum cavity. The cavity also can be fabricated by forming metallization on five sides of a foam block.

In this embodiment, the central opening 220 in the middle ground plane 212 has an area about equal to the area of the cross-section of the cavity 224. However, in other embodiments, the opening 220 in the middle ground plane 212 may be smaller than the cross-section of the cavity 224.

This embodiment is suitable for array applications because the vias 216 and 222 help isolate the patch antenna from adjacent patch antennas disposed on the same substrates 206 and 208.

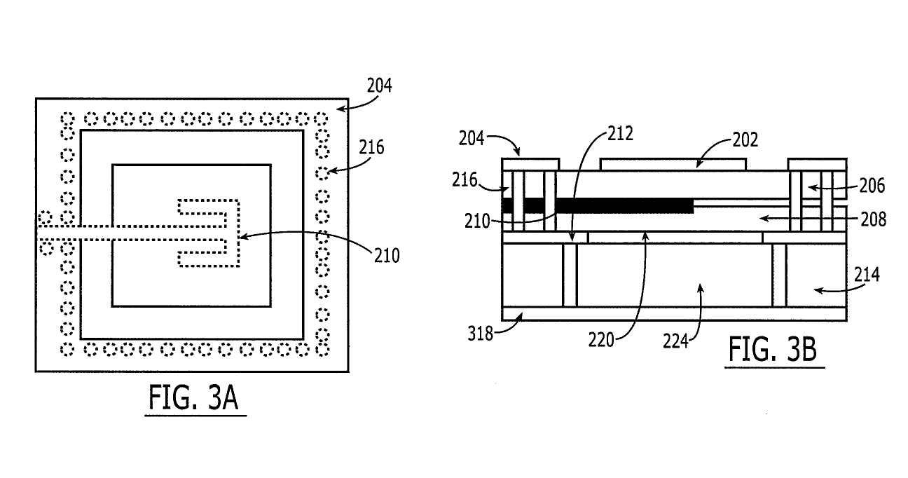

FIGS. 3A and 3B are top plan and cross-sectional side views, respectively, of a second embodiment of the present invention. This embodiment is largely identical to the first embodiment. Components that are identical or substantially identical are labeled with the same reference characters as in the embodiment of FIGS. 2A and 2B. In this embodiment, the bottom ground plane 318 is continuous over the entire bottom of the foam 214. This embodiment may lower manufacturing costs because the bottom ground plane does not need to be etched and can just be deposited on the bottom of the foam (or dielectric) layer 214.

The two geometries illustrated by FIGS. 2A-2B and 3A-3B, respectively, are suitable for array applications since the vias and the cavities formed by them help isolate the surface waves generated in the adjacent patches from each other. Furthermore, a plurality of patches may be stacked together for the purpose of achieving broader bandwidth and higher gain. Particularly, one or more additional patches can be disposed vertically above the first patch 202. Another layer of foam like foam layer 214 can be used as a dielectric spacer between the two (or more) patches.

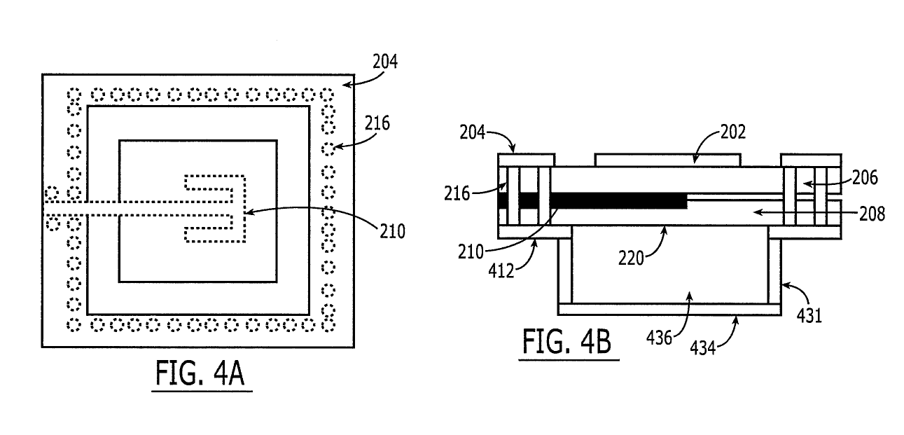

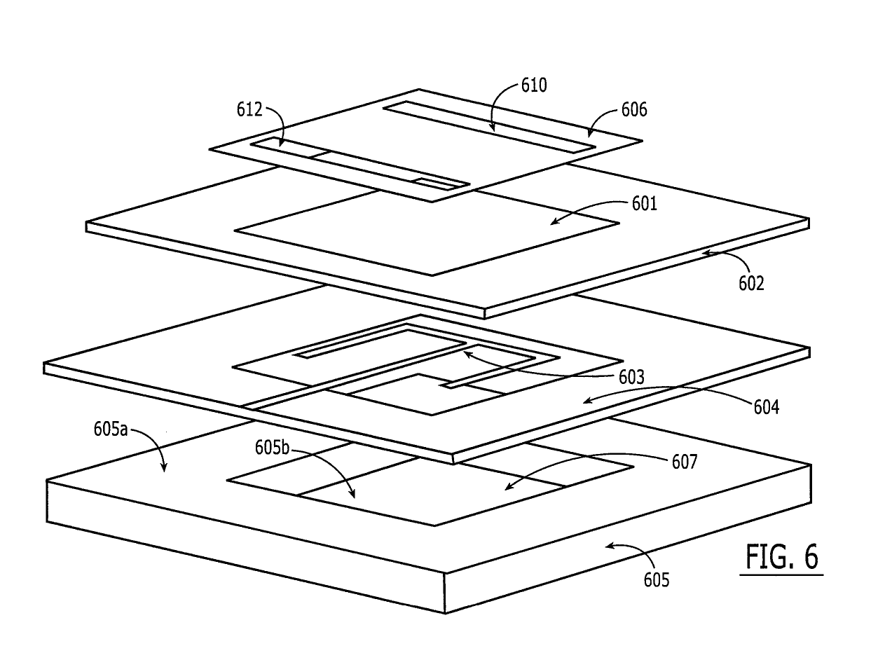

FIGS. 4A and 4B are top plan and cross-sectional side views, respectively, of a third embodiment of the present invention. This embodiment is similar to the first and second embodiments discussed above. Components that are identical or substantially identical are labeled with the same reference characters as in the previous embodiments. In this embodiment, everything above the middle ground plane can be essentially the same as in the previous embodiments. In fact, middle ground plane 412 can be essentially identical to middle ground plane 212 of the previous embodiments. However, below the middle ground plane, the cavity 436 is an air cavity or vacuum cavity defined by metal walls 431. Specifically, in the embodiment shown in FIGS. 4A and 4B, a peripheral wall 431 extends downwardly from the inner peripheral edge of the middle ground plane 412 to a bottom metal wall 434. Alternately, the cavity 436 can be defined by a five-sided unitary conductive box (or slab 605 illustrated in FIG. 6 discussed further below) in which the upper surface 605a of the box forms the middle ground plane. There are no lower conductive vias in this embodiment. The geometry of FIGS. 4A and 4B also is suitable for antenna arrays.

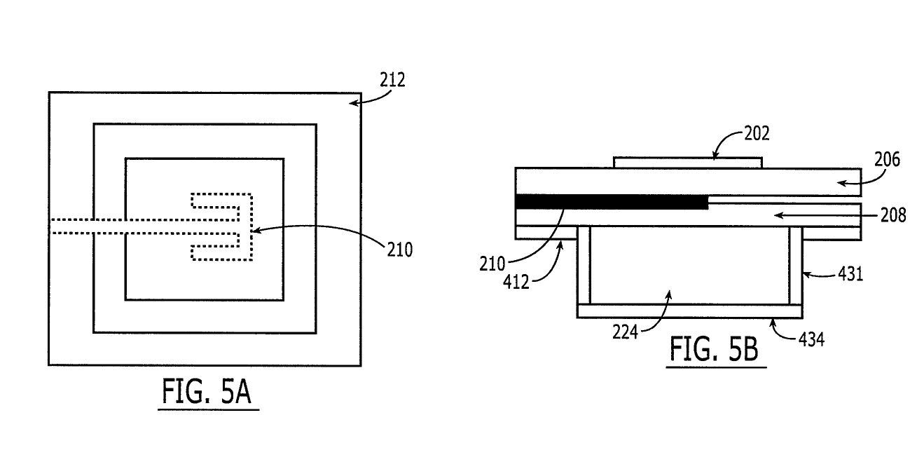

FIGS. 5A and 5B are top plan and cross-sectional side views, respectively, of a fourth embodiment of the present invention. This embodiment is similar to the third embodiment illustrated in FIGS. 4A and 4B and discussed above. Components that are identical or substantially identical are labeled with the same reference characters as in the previous embodiments. This embodiment differs from the third embodiment of FIGS. 4A and 4B in that there is no upper ground plane 204 (or upper vias 216 running between the upper and middle ground planes).

This embodiment also is readily adaptable to a stacked patch antenna configuration having two or more patches vertically stacked on top of each other (e.g., separated by dielectric foam layers). On the other hand, due to the lack of a top ground plane peripherally surrounding the patch 202, this would not be a preferred embodiment for array embodiments because of the reduced isolation between adjacent patches. For instance, this embodiment might be particularly suitable for RFID (radio frequency identification) applications, in which such antennas are used for tracking inventory in warehouses and retail stores. In such applications, the patch antennas are not arranged in arrays, but as individual patch antennas.

FIG. 6 is an exploded perspective view of a single stacked patch antenna in accordance with the present invention. However, it should be understood that the substrate and foam layers may be large and that multiple patch antennas in accordance with this and other embodiments of the present invention may be disposed side-by-side on those layers to create large scale patch antenna arrays.

In any event, a patch 601 is disposed on top of a substrate 602 such as a sheet of 10 mil thick RO4350 substrate. If second or further stacked patches are desirable, then additional patches such as patch 606 can be stacked on top of patch 601. The second and subsequent patches may be spaced from each other by layers of foam as previously noted.

Substrate 602 bearing first patch 601 is disposed on top of a second layer of RO4350 substrate 604 (or any other suitable substrate) upon which feed line 603 has been deposited and etched. The bottom surface of substrate 604 is copper plated around its periphery as shown so that it can be more easily soldered to the metal box 605 described immediately below. A five-sided metal box 605 defining an internal cavity 607 is attached to the bottom of second substrate 604 such as by adhesive or other means. The box 605 may be a metal slab with the cavity 607 machined into the top surface. In this particular configuration, the upper surface 605a of the box 605 (as well as the metallization on the bottom of substrate 604) essentially acts as the middle ground plane, while the bottom surface 605b of the box comprises the bottom ground plane.

Box 605 preferably is formed of a metal material such as zinc, aluminum, copper, steel or gold, milled or machined to form cavity 607. Alternatively, it may be formed of a semiconductive or insulating material formed by conventional photolithographic techniques. If box 605 is a semiconductor or insulator, however, then the surfaces of cavity 607 as well as top and bottom surfaces 605a and 605b should be plated with a thin layer of conductive material, preferably a metal such as gold.

Cavity 607 in box 605 may be filled with a foam or other dielectric material to provide structural support to feed line 603. However, in the illustrated embodiment, the cavity is filled with air or is a vacuum.

The second patch 606 in FIG. 6 illustrates a further feature that may be incorporated into a patch antenna in accordance with the present invention. Specifically, slots 610 and 612 have been added in the second patch 606, perpendicular to the direction of the electromagnetic field in the patch. These slots 610 and 612 reduce the capacitive loading of the patch 606 and provide a longer current path for electrical currents between the peripheral edge of the patch and the center of the patch, thereby artificially increasing the electrical length of the current paths. Accordingly, the dimensions of the patch 606 may be smaller without negatively impacting the antenna characteristics. Alternatively, a single slot may also be used.

Advantageously, the use of slots in the resonant patch element and their arrangement perpendicular to the E-field as shown in FIG. 6 make the stacked patch antenna smaller (even though it is placed on foam, a very low dielectric constant substrate), resulting in reduced mutual coupling between neighboring antenna elements, and thereby improving antenna gain, radiation patterns, and bandwidth.

The present invention provides a patch antenna or patch antenna array with greater bandwidth than conventional patch antennas. It also is smaller, lighter and less expensive because it can be manufactured using thinner substrate layers, such as flexible substrates, and lightweight and inexpensive foam layers instead of substrate layers for some of the layers.

A patch antenna or patch antenna array in accordance with the present invention can be manufactured using any of a number of well known semiconductor fabrication techniques.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A patch antenna for transmitting or receiving a signal, comprising:
a first substrate layer;
a patch disposed on said first substrate layer for transmitting or receiving said signal;
a feed line disposed proximate and beneath said patch for capacitive coupling to said patch;
a first ground plane disposed proximate and beneath said feed line;
a second ground plane disposed proximate and beneath said first ground plane; and
a cavity defined between said first and second ground planes.

2. A patch antenna as set forth in claim 1 further comprising a third ground plane disposed coplanar with and peripherally surrounding said patch.

3. A patch antenna as set forth in claim 2 further comprising a first plurality of conductive vias extending between and electrically connecting said third and first ground planes.

4. A patch antenna as set forth in claim 3 wherein said first plurality of vias peripherally surround said patch.

5. A patch antenna as set forth in claim 4 further comprising:
a second substrate layer beneath said feed line, said feed line being disposed on said second substrate layer.

6. A patch antenna as set forth in claim 5 further comprising:
a dielectric layer disposed between said first ground plane and said second ground plane.

7. A patch antenna as set forth in claim 6 further comprising:
a second plurality of conductive vias extending between and electrically coupling said first ground plane and said second ground plane.

8. A patch antenna as set forth in claim 7 wherein said second plurality of vias define a periphery of said cavity.

9. A patch antenna as set forth in claim 1 wherein said first ground plane defines an opening between said cavity and said feed line.

10. A patch antenna as set forth in claim 9 wherein said first ground plane has a square periphery and said opening is square.

11. A patch antenna as set forth in claim 1 wherein said second ground plane is smaller in the horizontal dimension than said first ground plane.

12. A patch antenna as set forth in claim 11 further comprising:
a plurality of conductive vias extending between and electrically coupling said first ground plane and said second ground plane.

13. A patch antenna as set forth in claim 12 wherein said second ground plane is about the same size in the horizontal dimension as said first ground plane.

14. A patch antenna as set forth in claim 7 wherein said vias comprising said first plurality of vias are collinear with said vias comprising said second plurality of vias.

15. A patch antenna as set forth in claim 7 wherein said vias comprising said first plurality of vias are not collinear with said vias comprising said second plurality of vias.

16. A patch antenna as set forth in claim 9 wherein said opening defined by said first ground plane is smaller than said second ground plane in the horizontal dimension.

17. A patch antenna as set forth in claim 9 comprising a conductive enclosure beneath said first ground plane, said conductive enclosure including a horizontally peripheral wall and a bottom wall, said bottom wall comprising said second ground plane.

18. A patch antenna as set forth in claim 17 further comprising a third ground plane disposed coplanar with and surrounding said patch.

19. A patch antenna as set forth in claim 18 further comprising a first plurality of conductive vias extending between and electrically connecting said third and first ground planes.

20. A patch antenna as set forth in claim 19 wherein said first plurality of vias peripherally surround said patch.

21. A patch antenna as set forth in claim 20 further comprising:
a second substrate layer beneath said feed line, said feed line being disposed on said second substrate layer.

22. A patch antenna as set forth in claim 9 comprising a conductive slab disposed beneath said feed line and having a top surface, a bottom surface, a peripheral surface, and a cavity therein, said cavity in open communication with said top surface of said slab, wherein said cavity in said slab comprises said cavity of said patch antenna, said top surface comprises said first ground plane and said bottom surface comprises said second ground plane.

23. A patch antenna as set forth in claim 22 further comprising a third ground plane disposed coplanar with and surrounding said patch.

24. A patch antenna as set forth in claim 23 further comprising a plurality of conductive vias extending between said third and first ground planes and electrically connecting them together.

25. A patch antenna as set forth in claim 24 wherein said vias peripherally surrounding said patch.

26. A patch antenna as set forth in claim 25 further comprising:
a second substrate layer beneath said feed line, said feed line being disposed on said second substrate layer.

27. A patch antenna array comprising a plurality of patch antennas as set forth in claim 2.

28. A patch antenna array as set forth in claim 27 wherein each of said plurality of patch antennas share said first substrate.
